(19) United States
(12) Patent Application Publication
(10) Pub. No.: US 2025/0003500 A1
(43) Pub. Date: Jan. 2, 2025

(54) VALVE FOR DISPENSER AND TAP DISPENSING SYSTEM USING THE SAME

(71) Applicant: SILGAN DISPENSING SYSTEMS CORPORATION, Richmond, VA (US)

(72) Inventors: JACOB VANBECELAERE, OLATHE, KS (US); SHAWN SUELTZ, RAYMORE, MO (US)

(21) Appl. No.: 18/695,453

(22) PCT Filed: Sep. 29, 2022
(86) PCT No.: PCT/US2022/045158

§ 371 Date: Mar. 26, 2024

Related U.S. Application Data
(60) Provisional application No. 63/250,956, filed on Sep. 30, 2021.

(51) Int. Cl. F16K 1/36; B67D 3/04

(52) U.S. Cl. CPC F16K 1/36; B67D 3/045

(57) ABSTRACT

A dispensing system including a tap dispenser having a shut off valve incorporating at least one projection thereon, wherein the at least one projection disrupts the flow of fluid across an interior surface of the shut off valve, thereby reducing the likelihood of bubble formation at the shut off valve following the closing of the shut off valve and cessation of fluid flow therethrough.

### CROSS-REFERENCE TO RELATED APPLICATIONS

This application claims the benefit of U.S. Provisional Application No. 63/250,956, entitled “VALVE FOR DISPENSER AND TAP DISPENSING SYSTEM USING THE SAME,” filed 30 Sep. 2021, and incorporates the same herein by reference in its entirety.

### BACKGROUND OF THE INVENTION

Field of the Invention: Embodiments of the invention relate to a valve for a dispenser and for flowable liquid products which may be incorporated into a dispensing system to reduce or eliminate formation of a bubble during or following the dispensing process.

State of the Art: Valves for dispensers are well known and there are many different types of valves used with dispensers and dispensing systems. In some dispensing systems-often called tap dispensers-a valve prevents the flow of a liquid product from a container until the valve is moved by a force being applied to the valve directly or indirectly, allowing product to flow past the valve. For example, tap dispensers are frequently used for dispensing laundry detergents, and especially liquid laundry detergents, being distributed from a large-format or large-quantity container. In use, a tap dispenser is provided with a valve that can be moved by application of a force by a user to the valve or to a stem or piston attached to the valve. While the valve is open, liquid flows past the valve, dispensing the liquid into a cup or desired location. When the force opening the valve is removed, the valve shuts, stopping the flow of liquid from the dispenser.

While the valve shuts off or stops the flow of liquid, in many instances a bubble is formed at the time of shut-off or immediately proceeding the shut-off or following the shut-off. The bubble invariably pops, scattering liquid in all directions. While some of the liquid forming the bubble may be caught in the desired cap, cup, or location where the user desires the liquid, the popping of the bubble occasionally creates an unwanted mess. Amongst consumers, this is one of the pain-points or problems with conventional tap dispensers.

A tap dispenser, or a valve for a tap dispenser, capable of reducing or eliminating the existence of a bubble upon closing of a tap dispenser is therefore desired.

### BRIEF SUMMARY OF THE INVENTION

A dispensing system according to certain embodiments of the invention may include an opening in fluid communication with the interior of a reservoir or a container that may be filled with a liquid or flowable product. A valve—or shut off valve—may be seated in the opening or in a valve seat associated with an opening in the tap dispenser to prevent fluid from passing the valve and exiting the opening when the valve is in an “Off” position. The valve may be moved such that in an “On” position, fluid passes the valve and is dispensed from the dispensing system.

A valve according to certain embodiments of the invention may include a shut off valve having one or more projections which may disrupt the flow of fluid over or around the valve. A valve may include an interior surface and an exterior surface, the interior surface in communication with a fluid or flowable material in the dispensing system. When the valve is moved into an open or “On” position and fluid flows past the valve and out an opening of the dispensing system, the fluid flows over the interior surface as it is being dispensed. According to embodiments of the invention, one or more projections are provided in the interior surface such that the fluid flow over the interior surface is disrupted, creating an uneven flow sheet of the fluid being dispensed.

In some embodiments of the invention, a valve may be molded with a projection extending off the interior surface of the valve. In other embodiments of the invention, bumps, projections, or other features may be mold integrally with, added to, or formed on the interior surface of the valve to disrupt the flow of fluid across an interior surface of the valve during operation.

In some embodiments, a valve according to various embodiments of the invention may be used with a tap dispensing system such as that illustrated and described in U.S. patent Ser. Nos. 10,526,191 and 10,994,985 or U.S. Patent Publication 2020-0399112A1, each of which is incorporated herein by reference in its entirety.

### BRIEF DESCRIPTION OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1 illustrates a tap dispenser attached to a container that may be used in accordance with various embodiments of the invention;

FIG. 2 illustrates a perspective view of an exterior of a tap dispenser according to various embodiments of the invention;

FIG. 3 illustrates a cross-sectional view of a tap dispenser according to various embodiments of the invention;

FIG. 4 illustrates a valve according to various embodiments of the invention;

FIG. 5 illustrates a valve according to various embodiments of the invention; and

FIG. 6 illustrates a cross-sectional view of a valve according to various embodiments of the invention.

### DETAILED DESCRIPTION OF THE INVENTION

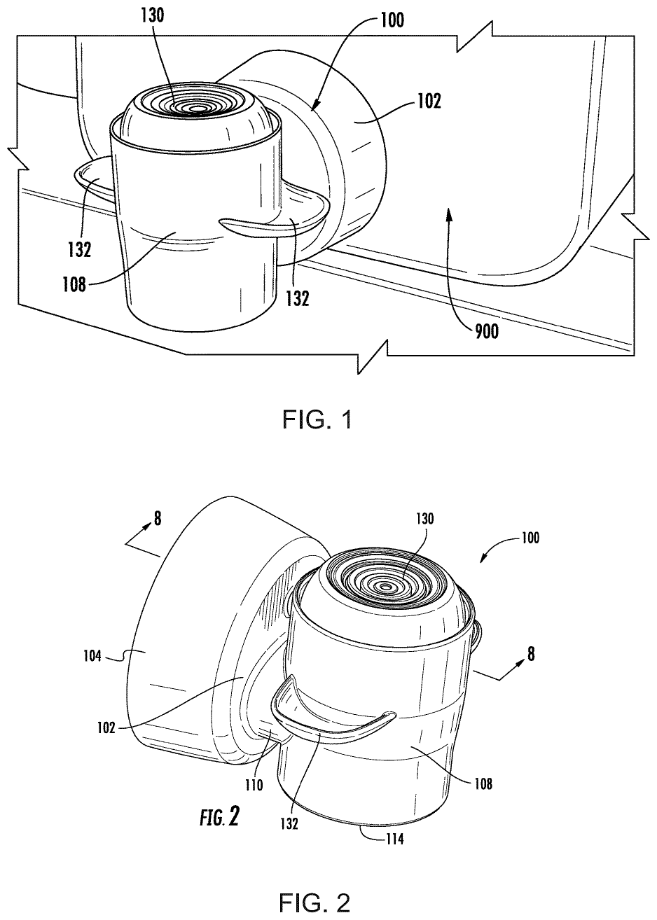

A tap dispenser 100 attached to a container 900 according to various embodiments of the invention is illustrated in FIGS. 1 and 2. As shown, a tap dispenser 100 may include a body 102 having a peripheral skirt 104, a dispensing head 108 and a throat 110 connecting the body 102 to the dispensing head 108. The throat 110 may provide a fluid flow path from an interior of the body 102 to an interior of the dispensing head 108. The interior of the body 102 may be in fluid communication with an interior of the container 900. The tap dispenser 100 includes an opening 114, mouth, or outlet through which product flowing through the tap dispenser 100 may exit or be dispensed. A button 130 or actuation surface may be seated in a second opening in the tap dispenser 100 opposite the opening 114. Force applied to the button 130 may open a valve, or disengage a valve from an interior surface of the tap dispenser 100, according to certain embodiments of the invention. Wings or finger holds 132 may be positioned on an exterior of the dispensing head 108 to facilitate the holding of the tap dispenser 100 or to assist with the application of a force against the button 130 or actuation surface.

The peripheral skirt 104 may include one or more connection systems to facilitate connection of the tap dispenser 100 to a container 900 and particularly to a neck connection associated with a container 900. The connection system may include any conventional connection system such as a threaded closure system, a bayonet closure system, or a system welded or otherwise permanently attached to the container 900.

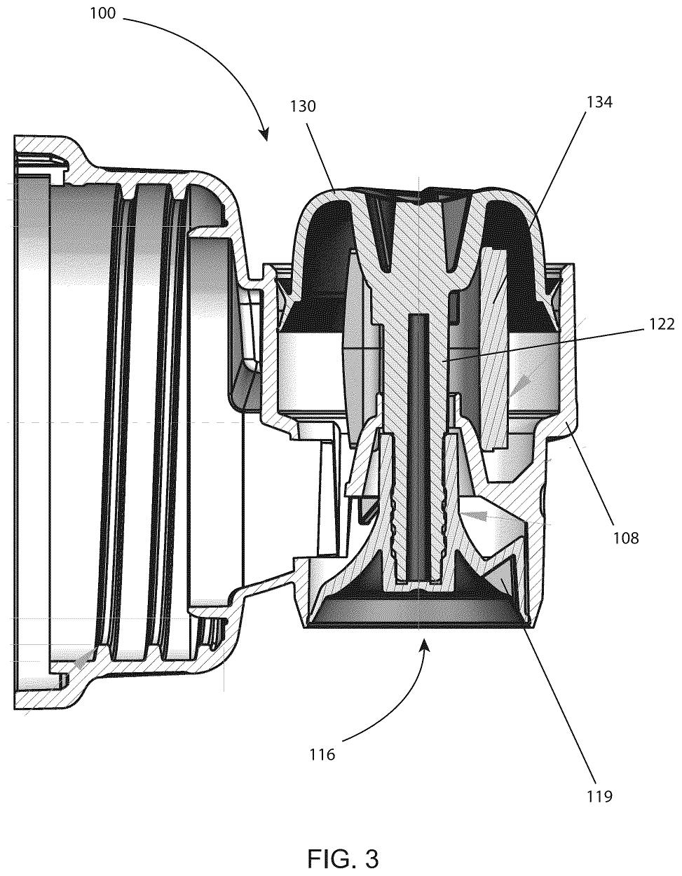

A cross-sectional view of a tap dispenser 100 according to various embodiments of the invention is illustrated in FIG. 3. As illustrated in FIG. 3, the button 130 may include an integrated or integral valve stem 122. The button 130 may also include one or more sealing portions to seal against an interior wall of the tap dispenser. The valve stem 122 may be connected to a shut off valve 116. For example, as illustrated in FIG. 3, a valve stem 122 may connect to the shut off valve 116 by a press-fit or snap-fit connection. Other connection systems between the shut off valve 116 and the valve stem 122 may also be used such as threaded connection, bayonet connection, or other type of connection.

While the valve stem 122 and button 130 are shown as a single, molded piece in FIG. 3, it is understood that the valve stem 122 and button 130 may be separate pieces or parts that connect to one another using conventional connections.

In some embodiments of the invention each of the button 130 and a portion of the tap dispenser body may include spring seats or spring grooves configured to work in conjunction with a conventional metal or plastic spring to provide a return force against the button 130 when a force is applied to the button 130 to open the shut off valve 116 of the tap dispenser 100. In other embodiments, such as that illustrated in FIG. 3, spring cones may support and provide a return force against a c-spring 134 such as that described in U.S. patent Ser. Nos. 10,526,191 and 10,994,985 or U.S. Patent Publication 2020-0399112A1.

In operation, a force may be applied to button 130 which in turn moves the valve stem 122 and the shut off valve 116, creating an opening between an edge of the shut off valve 116 and the body of the tap dispenser 100 through which fluid may flow from an interior of the tap dispenser 100 and an associated container 900. The spring 134 may apply a closing force to the button 130 or valve stem 122 causing the shut off valve 116 to return to an “Off” or closed position once the force applied to the button 130 is reduced or removed. In this manner, the shut off valve 116 may be opened—or turned “On”—to dispense product from the tap dispenser 100 and closed—or turned “Off”—to stop such flow from the tap dispenser 100.

When in an “On” or open position, fluid from within a container 900 attached to the tap dispenser 100 flows through an interior of the tap dispenser 100, over an interior surface 190 of the shut off valve 116, and out of the tap dispenser 100. The presence of one or more projections 119 associated with the shut off valve 116 may break-up or disrupt the flow of fluid over the interior valve surface 190 and out of the tap dispenser 100. The disruption of the fluid flow- and change of the flow over the entire surface of the shut off valve-helps to disrupt the formation of a bubble around the tap dispenser 100 opening adjacent the shut off valve 116 when the shut off valve 116 is moved from an “On” position to an “Off” position.

In some embodiments of the invention, a projection 119 may extend from the interior surface 190 of the shut off valve 116 away towards an opening in which the button 130 is seated. At least one surface of the projection 119 may engage an inner wall or surface of the tap dispenser body to further create disruption in a sheet of fluid flowing over the shut off valve 116. For example, as the shut off valve 116 moves from an “On” or open position where fluid is flowing past the shut off valve 116 into an “Off” or closed position where fluid flow is stopped, a surface of a projection 119 may engage an inner surface of the tap dispenser, thereby breaking up or stopping contact of a fluid sheet flowing over the interior surface 190 of the shut off valve 116. The disruption of the fluid sheet by the projection 119 and interaction of the projection 119 with the inner surface of the tap dispenser helps to disrupt fluid flow and prevent the formation of a bubble at the shut off valve 116 opening as the shut off valve 116 is closed.

As illustrated in FIGS. 3 through 6, a projection 119 may include a projection extending off of, or away from, the interior surface 190 of the shut off valve 116. As illustrated in FIGS. 3 through 6, a projection 119 may include a projection 119 having a partial triangular-shaped cross-section. The projection 119 may extend vertically away from the rim or edge of the shut off valve 116. For example, the shut off valve may include a valve lip 194 around a circumference of the shut off valve 116. With the shut off valve 116 seated on a flat surface or plane with the valve lip 194 engaging the flat surface or plane, the projection 119 may include a vertical wall extending up and away from the flat surface or plane. The vertical wall may be parallel to a central axis of the shut off valve 116. At the peak of the projection 119, a sloping wall back towards the interior surface of the shut off valve 116 may be present. The projection 119 may be formed in the shut off valve 116 such that it may be molded integrally therewith. In other embodiments, the projection 119 may be attached to the shut off valve 116. In still other embodiments, the projection 119 may be molded or attached to the shut off valve 116 during the molding process.

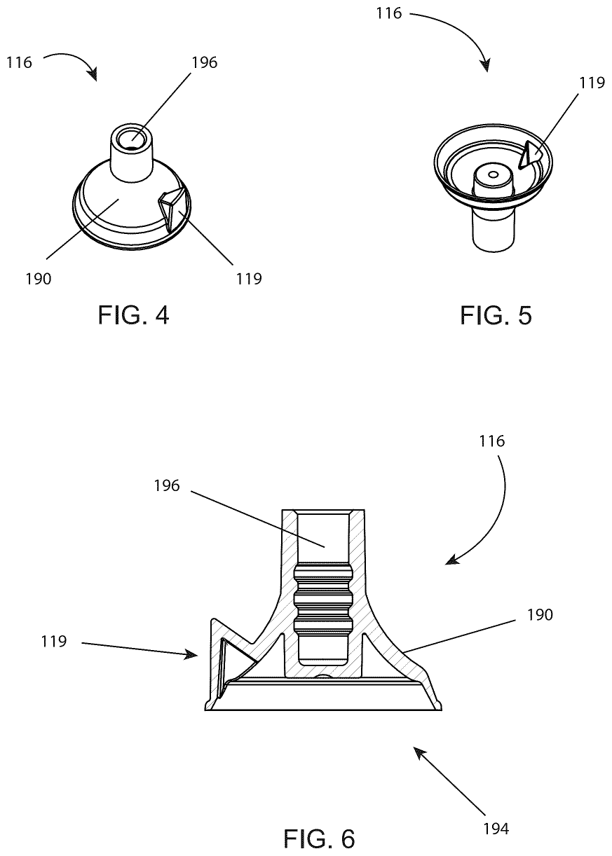

A top, perspective view of a shut off valve 116 according to certain embodiments of the invention is illustrated in FIG. 4. As shown, a shut off valve 116 may include a domed valve shape with a valve stem opening 196 extending off of the domed shape. The valve stem opening 196 may be configured to accept a valve stem 122 or connect to a valve stem 122. While the valve stem connection 196 illustrated in FIGS. 3 through 6 shows a female-type opening, a shut off valve 116 according to various embodiments of the invention could instead include a male connection feature configured to fit into a female opening on a valve stem 122. Connection features conventionally used to connect and hold components of dispensers and pumps may be used with various embodiments of the invention to connect the shut off valve 116 to a valve stem 122.

As illustrated in FIG. 4, a projection 119 may be positioned near an outer edge of the shut off valve 116. The projection 119 may project upwardly from the interior surface 190 of the shut off valve 116. As fluid flows over the interior surface 190 of the shut off valve 116, fluid parts around the projection 119 such that the flow of the fluid and the sheet of fluid is disrupted. The disruption of the fluid caused by the projection 119 creates an environment where it is more difficult for a bubble to form off of the shut off valve 116 about the valve lip 194 when the shut off valve 116 closes or seals against an interior portion of the tap dispenser 100.

As illustrated in FIG. 5, an interior portion of the projection 119 may be hollow. In other embodiments, the projection 119 may be solid. The projection 119 may extend upwards or away from the interior surface 190 of the shut off valve 116 in the direction from which the fluid flow comes such that it breaks-up the fluid sheet or fluid flow over the shut off valve 116.

A cross-sectional view of a shut off valve 116 according to various embodiments of the invention is illustrated in FIG. 6. As illustrated, the projection 119 may include a generally triangular-shaped cross-sectional shape. According to embodiments of the invention, the projection 119 creates a different flow path over a portion of the interior surface 190 of the shut off valve 116. As shown, the slope on one side of shut off valve 116 is slightly concave whereas the slope adjacent the projection 119 is not, and instead the projection 119 creates a barrier to disrupt and delay the flow of fluid or product around the projection 119. This disruption helps to reduce or eliminate the unwanted formation of a bubble at the shut off valve 116 position upon the stoppage of fluid flow through the shut off valve 116.

While FIGS. 3 through 6 illustrate a particular version of a shut off valve 116 having a projection 119 as illustrated and described herein, it is understood that tap dispensers 100 having shut off valves 116 with other types of projections could also be used. For example, a shut off valve 116 could have an interior surface 190 having a bump, such as a semi-circular formation, on the interior surface 190, the bump creating enough disruption to prevent the formation of a bubble upon closure of the shut off valve 116. In other embodiments, the interior surface 190 of the shut off valve 116 may be studded with two or more bumps or projections to disrupt flow. Furthermore, the shut off valve 116 may include different shapes and is not limited to the domed shape illustrated in FIGS. 3 through 6.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

What is claimed is:

1. A shut off valve, comprising:
a domed valve;
an interior surface;
an exterior surface;
a valve stem connection extending off of the interior surface; and
a projection extending off of the interior surface.

2. The shut off valve of claim 1, wherein the interior surface is convex.

3. The shut off valve of claim 1, wherein the interior surface has a concave slope.

4. The shut off valve of claim 1, wherein the projection comprises a plurality of projections extending off of the interior surface.

5. The shut off valve of claim 1, further comprising a valve stem connection extending off of the interior surface.

6. The shut off valve of claim 1, further comprising an outer circumference of the domed valve and a valve lip about said outer circumference.

7. A tap dispenser, comprising:
a dispensing head comprising an interior space;
a first opening in the dispenser head;
a second opening in the dispenser head opposite the first opening;
a button seated in the first opening;
a shut off valve seated in the second opening and having an interior surface; and
at least one projection extending off the interior surface towards the first opening.

8. The tap dispenser of claim 7, further comprising a body and a throat, the body connected to the throat and the throat connected to the dispensing head.

9. The tap dispenser of claim 7, further comprising a valve stem positioned between and in communication with the button and the shut off valve.

10. The tap dispenser of claim 7, further comprising a valve lip about an outer circumference of the shut off valve.

11. The tap dispenser of claim 10, wherein the at least one projection comprises a projection originating adjacent the valve lip and extending in the direction of the first opening.

12. The tap dispenser of claim 7, wherein the at least one projection comprises at least one projection extending off the interior surface and engaging an inner surface of the dispensing head in a closed position.

13. The tap dispenser of claim 7, wherein the at least one projection comprises a plurality of bumps on the interior surface.

14. The tap dispenser of claim 7, wherein the at least one projection comprises a vertical face extending parallel to a central axis of the shut off valve from the interior surface towards the button.

15. A dispensing system, comprising:
a container; and
a tap dispenser attached to the container, comprising:
a dispensing head comprising an interior space;
a first opening in the dispenser head;
a second opening in the dispenser head opposite the first opening;
a button seated in the first opening;
a shut off valve seated in the second opening and having an interior surface; and
at least one projection extending off the interior surface towards the first opening.

16. The dispensing system of claim 15, further comprising a valve lip about an outer circumference of the shut off valve and wherein the at least one projection comprises a projection originating adjacent the valve lip and extending in the direction of the first opening.

17. The dispensing system of claim 15, wherein the at least one projection comprises at least one projection extending off the interior surface and engaging an inner surface of the dispensing head in a closed position.

18. The dispensing system of claim 15, wherein the at least one projection comprises a plurality of bumps on the interior surface.

19. The dispensing system of claim 15, wherein the at least one projection comprises a vertical face extending parallel to a central axis of the shut off valve from the interior surface towards the button.
